(19) United States
(12) Patent Application Publication
(10) Pub. No.: US 2025/0210834 A1
(43) Pub. Date: Jun. 26, 2025

(54) SECONDARY BATTERY WITH ELECTROLYTE INJECTION PORT

(71) Applicant: SK ON CO., LTD., Seoul (KR)

(72) Inventors: Soo Min PARK, Daejeon (KR); Hyung Ju PAIK, Daejeon (KR); Hae Ryong JEON, Daejeon (KR); Hoemin CHEONG, Daejeon (KR); Won Tae HEO, Daejeon (KR); Soo In PARK, Seoul (KR)

(21) Appl. No.: 18/986,421

(22) Filed: Dec. 18, 2024

(30) Foreign Application Priority Data
Dec. 22, 2023 (KR) 10-2023-0190063

(51) Int. Cl. H01M 50/636; H01M 50/15

(52) U.S. Cl. CPC H01M 50/636; H01M 50/15

(57) ABSTRACT

Secondary batteries are disclosed. In an embodiment of the disclosed technology, a secondary battery may include: a case that accommodates an electrode assembly; a cap plate disposed on the case to seal an opening of the case; an electrolyte injection port disposed in the cap plate to inject an electrolyte into an internal space of the case; a sealing member that seals the electrolyte injection port. The sealing member may include: an inner cap fastened to an inner surface of the electrolyte injection port; and an outer cap inserted into and fastened to the inner cap and configured to elastically compress the inner cap toward the inner surface, thereby improving the safety of the secondary battery.

### CROSS-REFERENCE TO RELATED APPLICATION(S)

This patent document claims the priority and benefits of Korean Patent Application No. 10-2023-0190063 filed on Dec. 22, 2023, the disclosure of which is incorporated herein by reference in its entirety.

### TECHNICAL FIELD

The disclosed technology relates to a secondary battery including an electrolyte injection port.

### BACKGROUND

Secondary batteries are energy storage devices that may be electrically charged or discharged. They are widely used in various applications that require electricity as a power source. For example, secondary batteries are used as energy storage devices in various systems ranging from small electronics, such as mobile phones, laptops, and tablets to larger systems, such as vehicles and aircraft. Recently, their use as a power source for vehicles has been actively sought.

### SUMMARY

The disclosed technology can be implemented in some embodiments to provide a secondary battery capable of improving a sealing structure of an electrolyte injection port.

In an embodiment of the disclosed technology can be implemented in some embodiments to provide a secondary battery with an enhanced sealing structure, capable of improving safety by responding effectively to changes in internal pressure.

In an embodiment of the disclosed technology can be implemented in some embodiments to provide a secondary battery capable of inducing smooth injection of an electrolyte.

A secondary battery based on some embodiments of the disclosed technology may be widely applied in green technology fields such as electric vehicles, battery charging stations, and solar power generation and wind power generation using other batteries. Additionally, the secondary battery based on some embodiments of the disclosed technology may be used in eco-friendly electric vehicles, hybrid vehicles, and other systems to prevent climate change by suppressing air pollution and greenhouse gas emissions.

A secondary battery based on some embodiments of the disclosed technology may include: a case that accommodates an electrode assembly; a cap plate disposed on the case to seal an opening of the case; an electrolyte injection port disposed in the cap plate to inject an electrolyte into an internal space of the case; a sealing member that seals the electrolyte injection port. The sealing member may include: an inner cap fastened to an inner surface of the electrolyte injection port; and an outer cap inserted into and fastened to the inner cap and configured to elastically compress the inner cap toward the inner surface.

In an embodiment, the outer cap may be screw-coupled to the inner cap and formed to be to gradually elastically compress the inner cap toward the inner surface as the outer cap moves inwardly by the screw-coupling.

In an embodiment, the inner cap may include an insertion path configured to receive the outer cap inserted, and a diameter of the insertion path may gradually decrease in an insertion direction of the outer cap.

In an embodiment, the inner cap may include an outer surface fastened to the inner surface, and a diameter of the outer surface may gradually decrease in an insertion direction of the outer cap.

In an embodiment, a diameter of the inner surface may gradually decrease in the insertion direction of the outer cap to correspond to the outer surface. The inner cap may be supported in the electrolyte injection port by aligning the outer surface of the electrolyte injection port with the inner surface of the electrolyte injection port.

In an embodiment, wherein the outer cap may include an insertion portion inserted into the inner cap, and a diameter of the insertion portion may gradually decrease in an insertion direction of the outer cap.

In an embodiment, the inner cap may be formed such that an outer surface of the electrolyte injection port has a predetermined diameter and extends both upwardly and downwardly, and a flange supported by a step surface formed in the electrolyte injection port may be disposed at an upper end of the outer surface of the electrolyte injection port.

In an embodiment, the inner cap may be formed such that a degree of elastic compression in a transverse direction varies between an upper region and a lower region depending on an insertion direction of the outer cap.

In an embodiment, at least a portion of the inner cap may be formed of an elastic material. The outer cap may include a hard material compared to the inner cap, and may be welded and fixed to the cap plate.

In an embodiment, the cap plate may include a first cap plate disposed on a first side of the case and a second cap plate disposed on a second side of the case opposite to the first side. The electrolyte injection port may include at least one of: a first electrolyte injection port included in the first cap plate; or a second electrolyte injection port included in the second cap plate.

In an embodiment of the disclosed technology, a secondary battery may include: a case that accommodates an electrode assembly; a cap plate disposed on the case to seal an opening of the case; an electrolyte injection port included in the cap plate to inject an electrolyte into an internal space of the case; and a sealing member that seals the electrolyte injection port. The sealing member may include: an inner cap including a first insertion path to provide an injection path for an electrolyte, and a second insertion path to provide an exhaust path for internal gas during an electrolyte injection, and an outer cap including: a first insertion portion inserted into and fastened to the first insertion path to close the first insertion path, and a second insertion portion inserted into and fastened to the second insertion path.

In some embodiments of the disclosed technology, the inner cap may include a protruding rib extending upward from a bottom surface of the inner cap by a predetermined height to form the first insertion path. The protruding rib may be formed such that an upper end of the protruding rib includes a predetermined gap and is disposed to be lower than an upper end of the inner cap, and may be formed to guide the electrolyte overflowing from the first insertion path through the gap to the second insertion path.

In an embodiment, the inner cap may include a discharge hole that communicates with the second insertion path. The second insertion portion may be spaced apart from the discharge hole by a predetermined gap, and the gap may be formed to buffer internal pressure transmitted to the outer cap.

In an embodiment, the inner cap may have a flange placed and supported within a settling groove provided in the cap plate.

In an embodiment, the outer cap may include a first chamfer disposed to correspond to a second chamfer provided on the cap plate, and welded and bonded between the cap plate and the outer cap.

In an embodiment, at least a portion of the inner cap may be integrated with the cap plate.

A secondary battery based on some embodiments of the disclosed technology may provide a sealing member for sealing an electrolyte injection port. The sealing member based on some embodiments of the disclosed technology may include an outer cap and an inner cap, and the inner cap may be formed to be elastically compressed by the outer cap. Accordingly, the sealing member may establish a more effective sealing structure with the case. Additionally, the sealing member may enhance the safety of the secondary battery by responding to changes in internal pressure of the case.

A sealing member based on some embodiments of the disclosed technology may include an outer cap and an inner cap, and a first insertion path and a second insertion path may be formed in the inner cap. The first insertion path may function as a passage for injecting the electrolyte, and the second insertion path may function as a passage for discharging gas inside the case. In this way, the first and second insertion paths may facilitate smoother injection of the electrolyte.

The technical effects achieved through the embodiments of the disclosed technology are not limited to those mentioned above.

### BRIEF DESCRIPTION OF DRAWINGS

Certain aspects, features, and advantages of the disclosed technology are illustrated by the following detailed description with reference to the accompanying drawings.

FIG. 1A is a schematic external perspective view of a secondary battery based on an embodiment.

FIG. 1B is a schematic exploded perspective view of the secondary battery illustrated in FIG. 1A.

FIG. 1C is a schematic internal cross-sectional view of the secondary battery illustrated in FIG. 1A.

FIG. 2A is a schematic exploded perspective view of a sealing member based on an embodiment.

FIG. 2B is a schematic cross-sectional view of the sealing member illustrated in FIG. 2A.

FIG. 2C is a schematic assembly flow diagram of the sealing member illustrated in FIG. 2A.

FIG. 3A is a schematic cross-sectional view of a sealing member based on another embodiment.

FIG. 3B is a schematic assembly state diagram of the sealing member illustrated in FIG. 3A.

FIG. 4A is a schematic cross-sectional view of a sealing member based on another embodiment.

FIG. 4B is a schematic assembly flow diagram of the sealing member illustrated in FIG. 4A.

FIG. 5A is a schematic cross-sectional view of a sealing member based on another embodiment.

FIG. 5B is a schematic assembly flow diagram of the sealing member illustrated in FIG. 5A.

### DETAILED DESCRIPTION

Various embodiments of the disclosed technology will now be described with reference to the attached drawings. These descriptions are merely examples and the present disclosed technology is not limited to the specific embodiments described in this patent document.

Secondary batteries may be classified into lead-acid batteries, nickel-cadmium batteries, nickel-hydrogen batteries, and lithium-ion batteries based on the material of the electrode. The choice of a specific type of secondary battery depends on factors such as design capacity, usage environment, and other requirements. Among these, lithium-ion batteries offer relatively high voltage and capacity compared to other types of secondary batteries. As a result, lithium-ion batteries are widely used in applications that demand high-density energy storage, such as vehicle battery packs.

Secondary batteries, such as lithium-ion batteries, primarily include a positive electrode material, a negative electrode material, a separator, and an electrolyte. The positive and negative electrode materials are separated by an insulating separator placed therebetween, and charging and discharging may be performed by the movement of ions through the electrolyte.

In certain types of secondary batteries, the electrolyte may be injected into a case including the positive electrode material, the negative electrode material, the separator, and other components. In this case, an injection port for injecting the electrolyte may be formed in the case or a cap plate. After the electrolyte is injected, the injection port is securely sealed. Generally, the injection port is sealed by pressing in a ball-shaped sealing member into place or using a similar method.

A secondary battery or a battery cell described in this specification may encompass a rechargeable battery. For example, the secondary battery may include a lead-acid battery, a nickel-cadmium battery, a nickel-hydrogen battery, and a lithium-ion battery. This description mainly assumes that the secondary battery is a lithium-ion battery. In general, a lithium-ion battery may have advantages in light weight, high energy density, low self-discharge rate and the like. However, it should be understood that the technical concepts described in this specification may be applied to other suitable types of batteries in addition to lithium-ion batteries.

The secondary battery described in the present specification may include a single physical unit, or a cluster unit in which the multiple base units are combined with each other. For example, the secondary battery may include a battery cell, a battery module, and a battery pack, according to the classification criteria generally used in a current automotive field. In the present description, the secondary battery is mainly assumed to be a battery cell, which is a single unit. In general, the battery cell is a basic component unit of a battery pack that includes a positive electrode material, a negative electrode material, a separator and an electrolyte. However, it should be understood that the technical concepts described in this specification may also be applied to other suitable types of cluster units, such as a battery module or a battery pack, as needed.

The secondary battery described in the present specification may include various packaging types. For example, the secondary battery may be packaged in a cylindrical, square, pouch, or coin shape, according to the classification criteria generally used in the current relevant field. In the present description, the secondary battery is mainly assumed to be packaged in a square shape. Square packaging, referred to as square batteries, may generally have advantages in durability, safety, and convenience of installation. However, it should be understood that the technical concepts described in this specification may be applied to other suitable packaging types such as cylindrical, pouch, and coin types as needed.

The secondary battery described in this specification may be used in various means requiring electric energy. For example, the secondary battery may be suitably used in the field of vehicles that use electric energy as a main or auxiliary power source. As another example, the secondary battery may be suitably used in the field of aircraft such as personal aircraft, unmanned aerial vehicles and drones, electronic devices such as mobile phones, laptop computers, and tablets, and electric tools such as electric drills, electric grinders and electric hammers. However, it should be understood that the secondary battery described in the present specification may be widely used in various means operating based on electric energy in addition thereto.

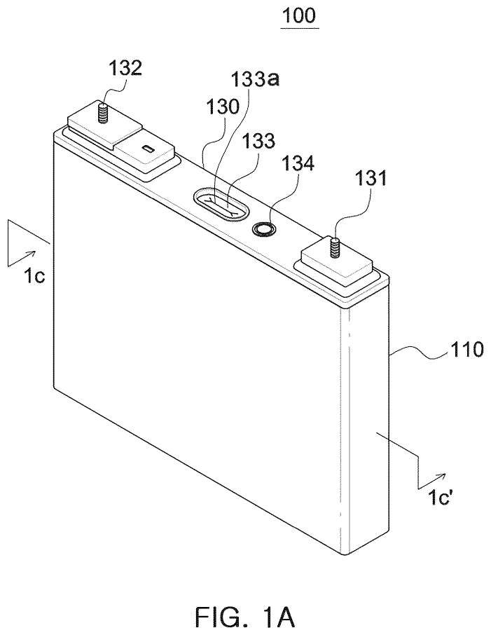

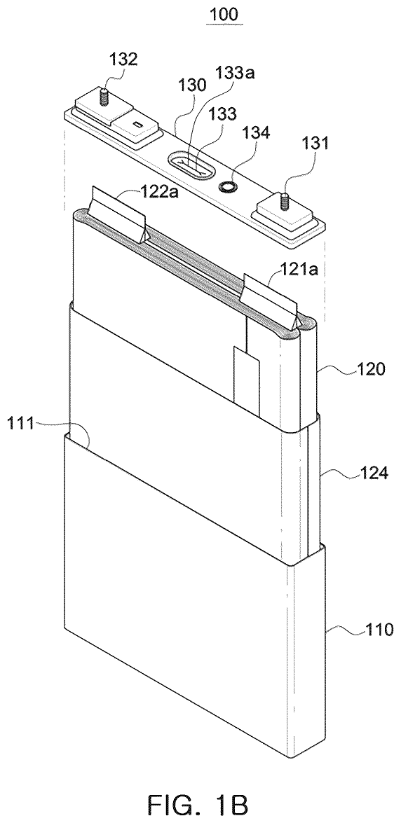

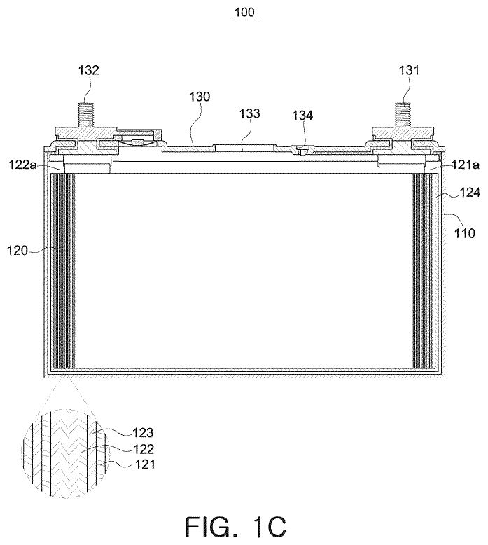

FIG. 1A is a schematic external perspective view of a secondary battery based on an embodiment. FIG. 1B is a schematic exploded perspective view of the secondary battery illustrated in FIG. 1A. FIG. 1C is a schematic internal cross-sectional view of the secondary battery illustrated in FIG. 1A. For example, FIG. 1C is a cross-sectional view taken along line 1c-1c′ of FIG. 1A.

For convenience of explanation, an embodiment exemplifies a single battery cell packaged in a square shape.

Referring to FIGS. 1A to 1C, a secondary battery 100 based on an embodiment may include a case 110.

The case 110 may provide an internal space in which an electrode assembly 120 or the like may be accommodated. In an embodiment, the case 110 is exemplified as having an approximately rectangular parallelepiped shape.

The case 110 may include an opening 111 connected to the internal space. In an embodiment, the opening 111 is exemplified as being provided in an upper end of the case 110. However, a position of the opening 111 may be changed as needed and is not necessarily limited to what is exemplified. The opening 111 may function as a passage for inserting an electrode assembly 120 or the like. Additionally, the opening 111 may function as a connection space for electrical connection between the electrode assembly 120 and an electrode terminal. The opening 111 may be closed by a cap plate 130.

A material of the case 110 may be appropriately selected in consideration of thermal and electrical conductivity, rigidity corresponding to swelling of the electrode assembly 120, processability, manufacturing costs, or the like. For example, the case 110 may be formed of a metal material including aluminum and an aluminum alloy.

In some implementations, the secondary battery 100 may include the electrode assembly 120.

The electrode assembly 120 may be disposed in an internal space of the case 110. If necessary, the electrode assembly 120 may be accommodated in an insulating bag 124 and disposed in the case 110.

The electrode assembly 120 may include a positive electrode material 121. The positive electrode material 121 may include a positive electrode current collector and a positive electrode active material. In some embodiments, the positive electrode current collector may include aluminum and an aluminum alloy, and the cathode active material may include lithium cobalt oxide, lithium manganese oxide, lithium nickel oxide, and lithium iron phosphate. The positive electrode active material may be coated on a surface of the positive electrode current collector. A partial region of the positive electrode current collector on which the positive electrode active material is not coated may function as a positive electrode tab 121a. In some embodiments, a plurality of positive electrode tab 121a may be provided, and some or all of a plurality of positive electrode tabs 121a may be mutually bonded to each other.

The electrode assembly 120 may include a negative electrode material 122. The negative electrode material 122 may include a negative electrode current collector and a negative electrode active material. In some embodiments, the negative electrode current collector may include copper, a copper alloy, nickel and a nickel alloy, and the negative electrode active material may include carbon and silicon. The negative electrode active material may be coated on a surface of the negative electrode current collector. A partial region of the negative electrode current collector on which the negative electrode active material is not coated may function as a negative electrode tab 122a. In some embodiments, a plurality of negative electrode tabs 122a may be provided, and some or all of the plurality of negative electrode tabs 122a may be bonded to each other.

The electrode assembly 120 may include a separator 123. The separator 123 may be disposed between a positive electrode material 121 and a negative electrode material 122. The separator 123 may function to limit physical contact between the positive electrode material 121 and the negative electrode material 122 and function to provide a passage for a movement of ions. In some embodiments, the separator 123 may be formed of a polymer material including polyethylene, polypropylene, or the like. Additionally, the separator 123 may include a dry and wet separator. In some embodiments, the separator 123 may include a coating layer including a ceramic coating layer.

The electrode assembly 120 may be formed by arranging the components in a manner such as winding, stacking, or the like. For example, the electrode assembly 120 may be formed in a structure in which the positive electrode material 121, the negative electrode material 122, and the separator 123 are wound around a longitudinal or transverse axis. Alternatively, the electrode assembly 120 may be formed in a structure in which the winding structure is compressed in a direction, approximately perpendicular to a winding axis. The winding structure may be referred to as a ‘jelly roll’ in the pertinent art.

As another example, the electrode assembly 120 may be formed in a structure in which the positive electrode material 121, the negative electrode material 122, and the separator 123 are sequentially stacked in an up-down direction (e.g., in a thickness direction or a height direction of the electrode assembly). In some cases, the separator 123 in the stack structure may be formed to have a structure in which a plurality of unit separators 123, continuous in a longitudinal direction, are sequentially folded and stacked according to stacking of the positive electrode material 121 and the negative electrode material 122. The stack structure may be referred to as ‘stack and folding,’ ‘Z-folding,’ or the like, in the pertinent art. However, in an embodiment, arrangements of each component of the electrode assembly 120 is not particularly limited. The electrode assembly 120 may have various arrangements other than those exemplified above.

In some embodiments, the electrode assembly 120 may be formed by combining a plurality of base units. For example, the electrode assembly 120 may include a base unit wound in a jelly roll manner, and two or more of the base units may be combined to form the electrode assembly 120. In an embodiment, the electrode assembly 120 is formed by combining two jelly roll units. As another example, the electrode assembly 120 may include a base unit wound in a stack-and-fold manner, and two or more of the base units may be combined to form the electrode assembly 120.

The electrode assembly 120 may be accommodated in an internal space of the case 110 together with an electrolyte. In some embodiments, the electrolyte may be formed of an organic solvent including a lithium salt. For example, the lithium salt may include lithium hexafluorophosphate (LiPF₆) and lithium tetrafluoroborate (LiBF₄) in a liquid or gel form, and the organic solvent may include a cyclic carbonate such as ethylene carbonate (EC) and propylene carbonate (PC), and a linear carbonate such as diethyl carbonate (DEC), dimethyl carbonate (DMC) and ethyl methyl carbonate (EMC).

In some other embodiments, the electrolyte may be omitted or replaced. For example, when an inorganic solid electrolyte is used, a liquid or gel electrolyte may be omitted.

In some implementations, the secondary battery 100 may include the cap plate 130.

The cap plate 130 may be formed to close the opening 111. In an embodiment, the cap plate 130 is exemplified as a square plate shape corresponding to the opening 111. The cap plate 130 may be coupled to the case 110 to seal the internal space of the case 110 in which the electrode assembly 120 is disposed. In some embodiments, the cap plate 130 may be welded to the case 110 by ultrasonic welding, laser welding, or the like.

A positive electrode terminal 131 and a negative electrode terminal 132 may be disposed on the cap plate 130. The positive electrode terminal 1 may be electrically connected to the positive electrode tab 121a of the electrode assembly 120, and the negative electrode terminal 132 may be electrically connected to the negative electrode tab 122a of the electrode assembly 120.

The cap plate 130 may include a vent 133. In an embodiment, the vent 133 is disposed between the positive electrode terminal 131 and the negative electrode terminal 132. However, a position of the vent 133 may be variously changed as needed, and is not necessarily limited to what is exemplified. In some other embodiments, the vent 133 may be disposed or added to the case 110. The vent 133 may be formed to open in response to the internal pressure of the case 110. The vent 133 may function to discharge the internal pressure to the outside of the case 110 to contribute to stabilizing the internal elements of the case 110. In an embodiment, the vent 133 may include a notch 133a having a predetermined shape. The notch 133a may be formed to partially open the internal space of the case 110 by inducing a breakage according to the internal pressure.

The cap plate 130 may include an electrolyte injection port 134. The electrolyte injection port 134 may be used to inject an electrolyte into the internal space of the case 110. In an embodiment, the electrolyte injection port 134 is disposed adjacent to the vent 133 in a central region of the cap plate 130. However, a position of the electrolyte injection port 134 may be variously changed and is not necessarily limited to what is exemplified.

The electrolyte injection port 134 may be properly sealed after an electrolyte injection process, a chemical reaction process, or the like. In an embodiment, the electrolyte injection port 134 may be sealed by a sealing member 400 described below.

A structure of the electrode assembly 120 illustrated in the disclosed technology is exemplary. In the disclosed technology, the electrode assembly 120 including the positive electrode tab 121a and the negative electrode tab 122a arranged in parallel from one side of the electrode assembly 120 is illustrated, but the positions and/or numbers of the positive electrode tab 121a and the negative electrode tab 122a are exemplary. For example, in an embodiment not illustrated, the positive electrode tab 121a and the negative electrode tab 122a may be disposed with the electrode assembly 120 (e.g., the positive electrode material 121, the negative electrode material 122, and the separator 123) interposed therebetween. At least a portion of the positive electrode tab 121a and the negative electrode tab 122a may be disposed between the case 110 and the electrode assembly 120, respectively.

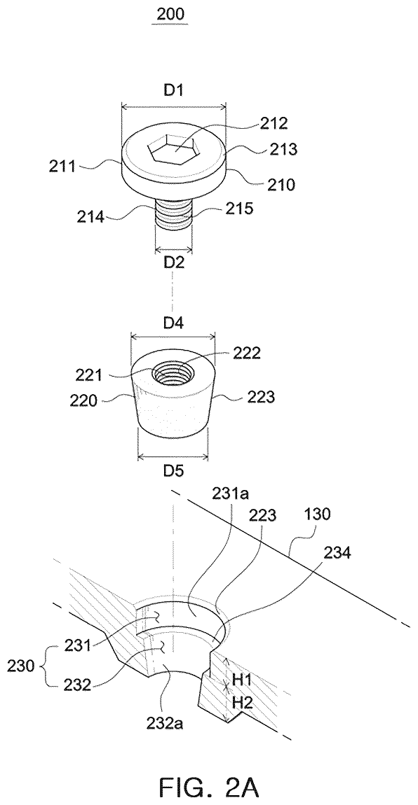

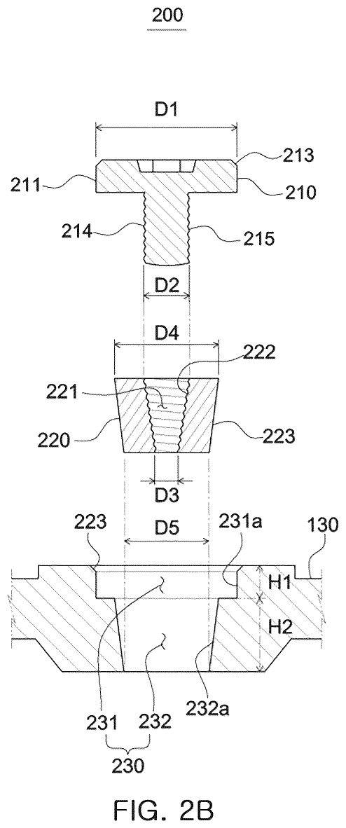

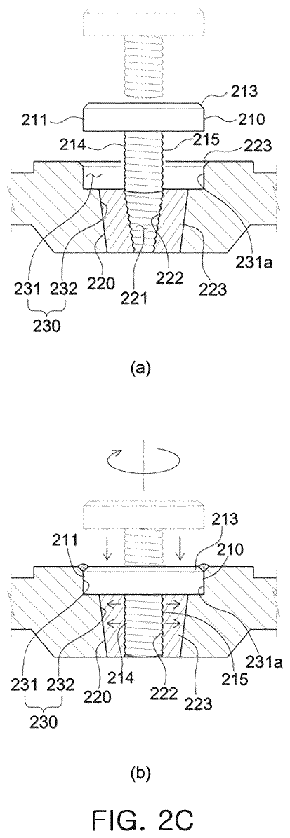

In the disclosed technology, a secondary battery 100 including the case 110 including one opening 111 and the cap plate 130 disposed on one side of the case 110 is illustrated, but this is exemplary. In an embodiment not illustrated, a secondary battery 100 including a plurality of cap plates 130 disposed on both sides of the case 110 may be provided. For example, the secondary battery 100 may include a first cap plate disposed on one side of the case 110 and a second cap plate disposed on the other side of the case 110. The electrolyte injection port 134 may be provided on at least one of the plurality of cap plates 130. For example, the electrolyte injection port 134 may include at least one of a first electrolyte injection port included in the first cap plate and a second electrolyte injection port included in the second cap plate. The secondary battery 100 may include at least one electrolyte injection port 134 provided in at least one of the first cap plate and the second cap plate, and at least one sealing member (e.g., a sealing member 200 of FIG. 2A) sealing the at least one electrolyte injection port.

FIG. 2A is a schematic exploded perspective view of a sealing member based on an embodiment. FIG. 2B is a schematic cross-sectional view of the sealing member illustrated in FIG. 2A.

Referring to FIGS. 2A and 2B, a sealing member 200 based on an embodiment may include an outer cap 210.

The outer cap 210 may form an upper structure of the sealing member 200. In an embodiment, the outer cap 210 may be formed of a metal or a hard material similar thereto. This is in contrast to an inner cap 220 described below being formed of an elastic material.

The outer cap 210 may include an upper portion 211. The upper portion 211 may have a first diameter D1 in a plane. A tool fastening portion 212 may be formed in the center of the upper surface of the upper portion 211. The outer cap 210 may be assembled with the inner cap 220 by being rotated by an assembly tool fastened to the tool fastening portion 212. A first chamfer 213 for welding with the cap plate 130 may be formed in an upper circumference of the upper portion 211.

The outer cap 210 may include an insertion portion 214. The insertion portion 214 may be formed to extend downwardly from a center of a bottom surface of the upper portion 211 by a predetermined length. The insertion portion 214 may have a second diameter D2 on a plane, and the second diameter D2 may be formed to be smaller than the first diameter D1 of the upper portion 211 by a predetermined degree. Additionally, a first spiral portion 215 may be formed on a lateral circumference of the insertion portion 214. The first spiral portion 215 may be screw-coupled to a second spiral portion 222 of an insertion path 221 described below.

In some implementations, the sealing member 200 may include the inner cap 220.

The inner cap 220 may be fastened to a lower portion of the outer cap 210. In an embodiment, the inner cap 220 may be formed of a material capable of performing elastic deformation by a predetermined degree. Alternatively, a portion or all of the inner cap 220 may be formed of an elastic material. The inner cap 220 may be in close contact with an inner surface 232a of the electrolyte injection port 134 according to the fastening of the outer cap 210 and may be elastically deformed.

The inner cap 220 may include the insertion path 221. The insertion path 221 may be formed to extend upwardly and downwardly penetrate through the center of the inner cap 220. The insertion portion 214 of the outer cap 210 may be inserted into and fastened to the insertion path 221.

In an embodiment, the insertion portion 214 of the outer cap 210 may be inserted into and fastened to the inner cap 220 while elastically deforming the inner cap 220. Specifically, the insertion portion 214 may be formed to elastically compress the inner cap 220 in a transverse direction while moving downwardly along the insertion path 221.

In an embodiment, the insertion path 221 is formed so that a diameter thereof decreases from an upper end to a lower end, and thus implements the insertion and compression fastening as described above. Specifically, an upper end of the insertion path 221 may have a second diameter D2 corresponding to the insertion portion 214, and a lower end of the insertion path 221 may have a third diameter D3 smaller than a diameter of the upper end by a predetermined degree. Additionally, the insertion path 221 may be formed so that a diameter thereof gradually decreases from the upper end to the lower end. A shape of the insertion path 221 may allow the inner cap 220 to be elastically compressed in a transverse direction as the insertion portion 214 enters the insertion path 221.

In some implementations, the second spiral portion 222 may be formed on an inner surface of the inner cap 220 surrounding the insertion path 221. The second spiral portion 222 may have a pitch to which the first spiral portion 215 of the outer cap 210 corresponds and may be screw-connected to the first spiral portion 215. The outer cap 210 and the inner cap 220 may be mutually assembled by screw-coupling between the first and second spiral portions 215 and 222. The first and second spiral portions 215 and 222 may allow the inner cap 220 to be elastically compressed in a transverse direction as the insertion portion 214 gradually enters the insertion path 221.

In some implementations, the inner cap 220 may include an outer surface 223. An outer surface 223 of the inner cap 220 may be connected to an inner surface 232a of an electrolyte injection port 230 described below. In an embodiment, the outer surface 223 of the inner cap 220 may be formed as an inclined surface in which a width thereof becomes narrower as the circumferential surface 223 moves downwardly. Specifically, the outer surface 223 of the inner cap 220 may have a fourth diameter D4 in an upper portion thereof, and may have a fifth diameter D5, smaller by a predetermined amount than the fourth diameter D4 in a lower portion thereof. In an embodiment, the fourth diameter D4 of the upper portion may be formed to be smaller by a predetermined amount than the first diameter D1 of the upper portion 211 of the outer cap 210, and the fifth diameter D5 of the lower portion may be formed to be larger by a predetermined amount than the second diameter D2 of the insertion portion 214 of the outer cap 210. The outer surface 223 of the inner cap 220 may be formed to extend obliquely between the upper portion having the fourth diameter D4 and the lower portion having the fifth diameter D5.

The outer surface 223 of the inner cap 220 formed as an inclined surface as described above may function as a support structure for an arrangement of the inner cap 220 during an installation process of the inner cap 220. That is, the outer peripheral surface 223 formed as the inclined surface may be settled on the inner peripheral surface 232a surrounding the electrolyte injection port 134, so that the inner cap 220 may be supported inside the electrolyte injection port 134.

In some implementations, the cap plate 130 may include an electrolyte injection port 230.

For reference, in FIG. 2A, and the like, a new reference numeral of an electrolyte injection port illustrated in FIG. 1A, and the like, is assigned for convenience of explanation. The description of the electrolyte injection port 134 of FIG. 1A, FIG. 1B and FIG. 1C may be applied to an electrolyte injection port 230 of FIG. 2A, FIG. 2B, and FIGS. 2C(a) and 2C(b).

The electrolyte injection port 230 is formed by penetrating through the cap plate 130, and may provide a passage for injecting the electrolyte into the internal space of the case 110.

In an embodiment, the electrolyte injection port 230 may include an upper region 231 and a lower region 232. The upper region 231 refers to a portion of the electrolyte injection port 230 disposed toward the outside of the case 110, and the lower region 232 refers to a remaining portion of the electrolyte injection port 230 disposed toward the inside of the case 110. The upper region 231 and the lower region 232 may be disposed in a thickness direction of the cap plate 130, thus forming one continuous electrolyte injection port 230 in the thickness direction.

The upper region 231 may be formed to accommodate the upper end 211 of the outer cap 210. The upper region 231 may have a first diameter D1 corresponding to the upper portion 211 of the outer cap 210, and may have a first height H1 corresponding to the upper portion 211. The upper portion 211 may be disposed in the upper region 231 and may be fixed to the cap plate 130 by welding or the like. A second chamfer 233 may be formed on an upper end of an inner surface 231a surrounding the upper region 231. The second chamfer 233 may be disposed to correspond to the first chamfer 213 of the outer cap 210 and may be used for welding.

The lower region 232 may be formed to extend from a lower end of the upper region 231 toward the inside of the case 110. The lower region 232 may be formed to accommodate the inner cap 220. In an embodiment, the inner surface 232a of the lower region 232 may be formed to extend obliquely to correspond to the outer surface 223 of the inner cap 220. Accordingly, the lower region 232 may have a fourth diameter D4 in an upper portion thereof, and may have a fifth diameter D5 in a lower portion thereof. The fourth diameter D4 corresponds to a diameter of an upper portion of the inner cap 220, and the fifth diameter D5 corresponds to a diameter of a lower portion of the inner cap 220. Additionally, the lower region 232 may have a second height H2 corresponding to an up-down height of the inner cap 220.

In an embodiment, a step surface 234 may be formed between the lower region 232 and the upper region 231. The step surface 234 may be formed in a boundary between the upper region 231 having the first diameter D1 and an upper end of the lower region 232 having the fourth diameter D4. The step surface 234 may have a predetermined width due to a difference between the first and fourth diameters D1 and D4, and may be formed to extend in in a circumferential direction in a boundary between the upper region 231 and the lower region 232.

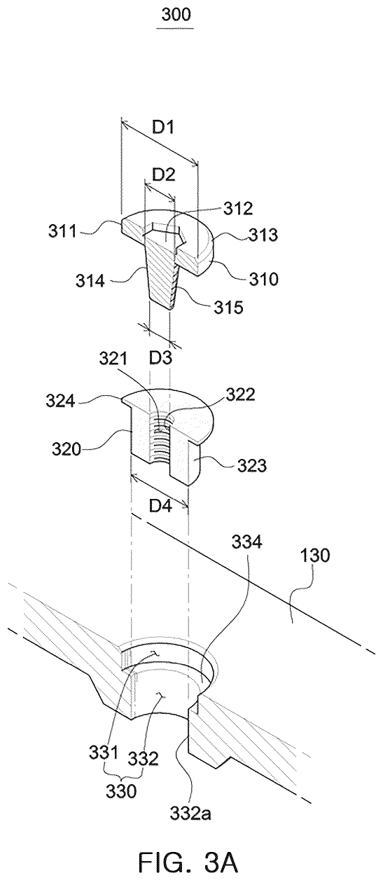

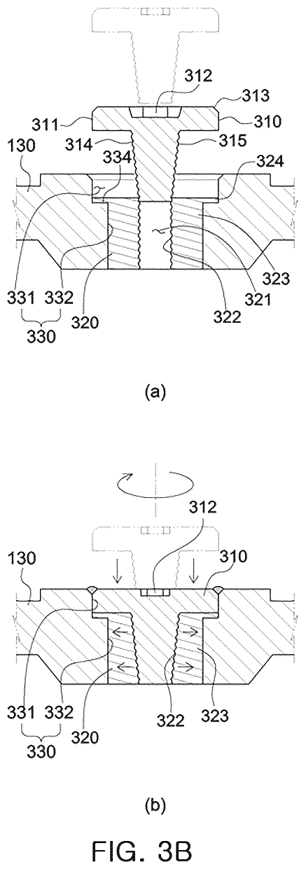

The step surface 234 may provide a support structure for the outer cap 210. That is, the outer cap 210 may be supported by settling a bottom surface of the upper portion 211 on the step surface 234. Accordingly, the step surface 234 may function to guide an assembly position of the outer cap 210. In some other embodiments, the step surface 234 may be used to support the inner cap 220. FIG. 3A and the like, which will be described below, illustrate a case in which the inner cap 220 is supported by the step surface 234 to guide the assembly position.

FIG. 2C is a schematic assembly flow diagram of the sealing member illustrated in FIG. 2A.

Referring to (a) of FIG. 2C, first, the inner cap 220 may be disposed in the electrolyte injection port 230. In an embodiment, the inner cap 220 may be supported by settling an inclined outer surface 223 on the inner surface 232a of the lower region 232. This may enhance the convenience of assembly.

Referring to (b) of FIG. 2C, next, the outer cap 210 may be fastened to the inner cap 220. The outer cap 210 may be fastened to the inner cap 220 while the insertion portion 214 is inserted into the insertion path 221 of the inner cap 220. Specifically, the outer cap 210 may be inserted into and fastened to the insertion path 221 while the first spiral portion 215 formed in the insertion portion 214 is screw-coupled to the second spiral portion 222 formed in the insertion path 221 of the inner cap 220. According to the screw-coupling, the outer cap 210 may enter downwardly toward the inside of the insertion path 221 while rotating about a longitudinal axis. Additionally, the outer cap 210 may enter while gradually compressing the inner cap 220 according to an inclination of an inner surface of the insertion path 221. That is, the outer cap 210 may be inserted into and fastened in the longitudinal direction while gradually compressing the inner cap 220 in a transverse direction. Accordingly, the outer surface 223 of the inner cap 220 may be firmly attached to the inner surface 232a of the lower region 232.

When the insertion portion 214 is completely inserted into the insertion path 221, the upper portion 211 of the outer cap 210 may be disposed in the upper region 231 of the electrolyte injection port 230. In an embodiment, the upper portion 211 of the outer cap 210 may be disposed to form a plane generally corresponding to an upper surface of the cap plate 130. Additionally, the first chamfer 213 of the outer cap 210 and the second chamfer 233 of the cap plate 130 may be disposed to correspond to each other, thus forming a groove for welding bonding. The outer cap 210 may be welded to the cap plate 130 in the first and second chamfers 213 and 233 and may be firmly fixed to the cap plate 130.

In an embodiment, the inner cap 220 may be formed to have different degrees of elastic compression in each position in the up-and-down direction by the inclination of the insertion path 221. That is, a lower region of the inner cap 220 in which a diameter of the insertion path 221 is formed to be relatively small, may be elastically compressed more strongly in the transverse direction than the upper region. For reference, in an embodiment described below, an inner cap 320 may have an upper region thereof elastically compressed in the transverse direction more strongly than a lower region thereof. However, in any case, the inner caps 220 and 320 may be elastically compressed to a certain degree in an initial state and may be firmly adhered to the inner surfaces 232a and 332a of the electrolyte injection port.

FIG. 3A is a schematic cross-sectional view of a sealing member based on another embodiment. FIGS. 3B(a) and 3B(b) are schematic assembly state diagrams of the sealing member illustrated in FIG. 3A.

For convenience, the following embodiments will be described with a focus on differences from the aforementioned embodiments.

Referring to FIGS. 3A and 3B, a sealing member 300 according to the present embodiment may include an outer cap 310 and an inner cap 320.

The outer cap 310 may form an upper structure of the sealing member 300. Additionally, the outer cap 310 may include an upper portion 311 having a tool fastening portion 312 formed therein, and an insertion portion 314 extending from the upper portion 311. This is generally similar to the above-described embodiment.

In an embodiment, the insertion portion 314 may be formed so that a diameter thereof decreases from an upper end to a lower end. This is compared to the above-described embodiment in which the diameter of the insertion path 221 is formed to be smaller. Specifically, the upper portion 311 of the outer cap 310 may have a first diameter D1, and the insertion portion 314 may have a second diameter D2, smaller by a predetermined amount than the first diameter D1 in an upper end. Additionally, the insertion portion 314 may have a third diameter D3, smaller by a predetermined amount than the second diameter D2 in a lower portion, and may be formed so that a diameter thereof gradually decreases from the upper end to the lower end. The shape of the insertion portion 314 as described above may allow the inner cap 320 to be elastically compressed in the transverse direction as the insertion portion 314 enters an insertion path 321.

In some implementations, a first spiral portion 315 may be formed on a lateral circumference of the insertion portion 314. The first spiral portion 315 may be formed to extend along an outer surface of the insertion portion 314 along the shape of the insertion portion 314 described above.

The inner cap 320 may be formed of an elastic material and may be fastened to a lower portion of the outer cap 310. The inner cap 320 may be in close contact with an inner surface 332a of an electrolyte injection port 330 and may be elastically deformed according to the fastening of the outer cap 310. This is generally similar to the above-described embodiment.

Additionally, the inner cap 320 may include an insertion path 321, and the insertion path 321 may be formed to penetrate through a center of the inner cap 320 vertically. In an embodiment, the insertion path 321 of the inner cap 320 has a third diameter D3 corresponding to a lower end of the insertion portion 314 and may be formed to extend upwardly and downwardly. Additionally, a second spiral portion 322 corresponding to the first spiral portion 315 of the outer cap 310 may be formed on an inner surface of the inner cap 320 surrounding the insertion path 321. Accordingly, the outer cap 310 and the inner cap 320 may be mutually assembled by screw coupling between the first and second spiral portions 315 and 322.

In some implementations, the inner cap 320 may include an outer surface 323, and the outer surface 323 may be fastened to the inner surface 332a of the electrolyte injection port 330. In an embodiment, the outer surface 323 of the inner cap 320 may be formed to extend vertically to have a predetermined diameter. That is, the outer surface 323 of the inner cap 320 may be formed to extend vertically to have a fourth diameter D4. This is compared to the outer surface 223 in the above-described embodiment in which the diameter thereof is formed to be smaller. The fourth diameter D4 may be formed to be greater by a predetermined degree than the third diameter D3 of the insertion path 321 and to be smaller by a predetermined degree than the first diameter D1 of the upper portion 311 of the outer cap 310.

In the case described above, the inner cap 320 may include a flange 324. The flange 324 may be formed to extend in the transverse direction by a predetermined width from the upper portion of the inner cap 320. An outer circumference of the flange 324 may have a first diameter D1 corresponding to the upper end 311 of the outer cap 310. Accordingly, the flange 324 may be supported by being settled on a step surface 334 of the electrolyte injection port 330.

The flange 324 of the inner cap 320 may replace an inclined outer surface 223 of the above-described embodiment, and may support the inner cap 320 in an assembly position. That is, the inner cap 320 of this embodiment may be supported in a predetermined assembly position in the electrolyte injection port 330 through the flange 324 because the outer surface 323 is formed to extend vertically upwardly and downwardly.

Additionally, the flange 324 of the inner cap 320 may form an additional sealing structure between the upper portion 311 of the outer cap 310 and an upper surface of the inner cap 320. That is, the flange 324 of the inner cap 320 may be interposed between a bottom surface of the upper portion 311 and an upper surface of the inner cap 320, thus functioning as a kind of sealing structure elastically compressed according to the insertion of the outer cap 310.

In some implementations, the cap plate 130 may include an electrolyte injection port 330.

In an embodiment, the electrolyte injection port 330 may have a structure and shape corresponding to the outer cap 310 and the inner cap 320 described above. Specifically, the electrolyte injection port 330 may include an upper region 331 and a lower region 332. The upper region 331 may have a first diameter D1 corresponding to the upper portion 311 of the outer cap 310, and the lower region 332 may have a fourth diameter D4 corresponding to the outer surface 323 of the inner cap 320. In an embodiment, the lower region 332 does not include an inclined surface, unlike the above-described embodiment. Additionally, depending on a difference between the first diameter D1 and the fourth diameter D4, a step surface 334 may be formed between the upper region 331 and the lower region 332.

When looking into the assembly order of the sealing member 300 as described above, the inner cap 320 may be firstly disposed in the electrolyte injection port 330. In an embodiment, the inner cap 320 may be disposed in the electrolyte injection port 330 as the flange 324 in an upper end thereof is settled and supported on the step surface 334.

Then, the outer cap 310 may be fastened to the inner cap 320. In the outer cap 310, while the first and second spiral portions 315 and 322 are screw-coupled, the insertion portion 314 may be inserted into and fastened to the insertion path 321. Additionally, the outer cap 310 may gradually compresses the inner cap 320 in the transverse direction according to the inclination of the outer surface 323 of the insertion portion 314, and may be inserted into and fastened to the insertion path 321. Accordingly, the outer surface 323 of the inner cap 320 may be firmly attached to the inner surface 332a of the lower region 332.

In some implementations, when the insertion portion 314 is completely inserted into the insertion path 321, the outer cap 310 may be welded to the cap plate 130 at first and second chamfers 313 and 333 and may be firmly fixed to the cap plate 130.

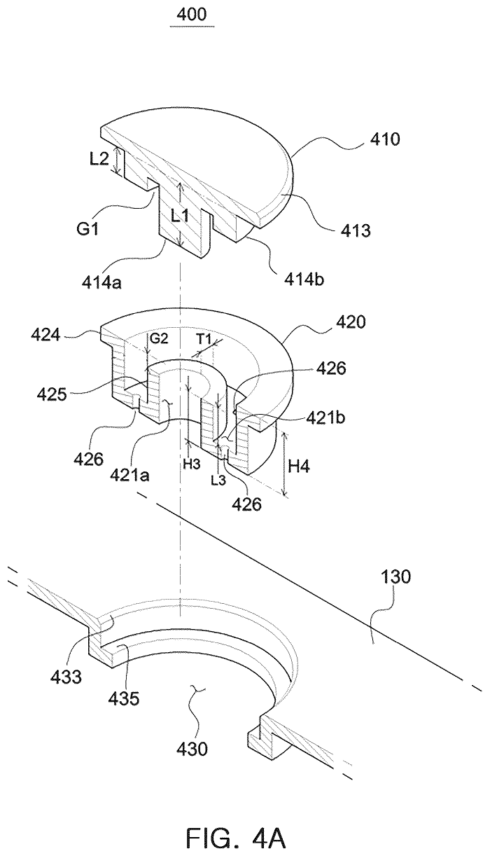

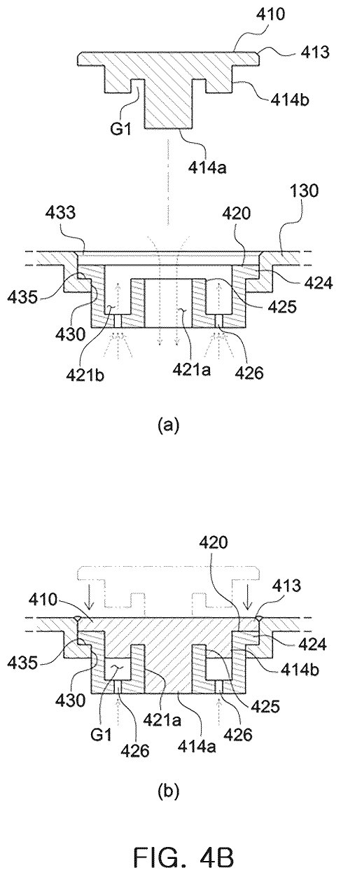

FIG. 4A is a schematic cross-sectional view of a sealing member based on another embodiment. FIGS. 4B(a) and 4B(b) are schematic assembly flow diagrams of the sealing member illustrated in FIG. 4A.

For reference, in the following embodiments, the convenience of electrolyte injection may be more considered as compared to the aforementioned embodiments.

Referring to FIGS. 4A and 4B, a sealing member 400 based on an embodiment may include an outer cap 410.

The outer cap 410 may include a first insertion portion 414a. The first insertion portion 414a may be formed to extend downwardly from a bottom surface of the outer cap 410 by a predetermined length. In an embodiment, the first insertion portion 414a is illustrated in the form of a circular column having a predetermined diameter and extending upwardly and downwardly.

The outer cap 410 may have a second insertion portion 414b. The second insertion portion 414b may be formed to protrude downwardly from the bottom surface of the outer cap 410 by a predetermined length. The second insertion portion 414b may be formed to be shorter by a predetermined amount than the first insertion portion 414a. That is, the first insertion portion 414a may have a first length L1 vertically, and the second insertion portion 414b may have a second length L2 shorter than the first length L1 by a predetermined length.

Additionally, the second insertion portion 414b may be spaced apart from the first insertion portion 414a by a predetermined gap G1 in the transverse direction. The gap G1 may be used for fastening with a protruding rib 425 described below. Accordingly, the gap G1 may be formed to correspond to a thickness T1 of the protruding rib 425. Additionally, the second insertion portion 414b may be formed to extend in the circumferential direction centered on the first insertion portion 414a. In other words, the second insertion portion 414b may have a circular ring shape in a plane.

Additionally, a first chamfer 413 for welding with the cap plate 130 may be formed in a circumference of an upper end of the outer cap 410.

In some implementations, the sealing member 400 may include an inner cap 420.

The inner cap 420 may include a first insertion path 421a. The first insertion path 421a may be formed to extend upwardly and downwardly from the center of the inner cap 420 and penetrate through the inner cap 420 upwardly and downwardly. The first insertion path 421a may be connected to the first insertion portion 414a of the outer cap 410. The first insertion portion 414a may be inserted into and fastened from an upper end of the first insertion path 421a, and the first insertion path 421a may be closed by the first insertion portion 414a. The first insertion path 421a may have a cross-sectional shape and size corresponding to the first insertion portion 414a so that the first insertion path 421a may be closed by the first insertion portion 414a. In an embodiment, the first insertion path 421a may have a circular shape and size corresponding to the cross-sectional shape of the first insertion portion 414a.

The inner cap 420 may include a protruding rib 425 forming the first insertion path 421a. The protruding rib 425 may be formed to extend upwardly from a bottom surface of the inner cap 420 by a predetermined height. In an embodiment, the protruding rib 425 may have a circular sleeve shape extending upwardly and downwardly. Additionally, the first insertion path 421a may be formed in a center of the protruding rib 425. The first insertion path 421a may be formed to extend by penetrating through the center of the protruding rib 425 upwardly and downwardly. The protruding rib 425 may have a thickness T1 corresponding to the gap G1 of the first and second insertion portions 414a and 414b described above, and may be inserted into and fastened to the gap G1.

In an embodiment, a vertical height H3 of the protruding rib 425 may be formed to be smaller than an overall height H4 of the inner cap 420 by a predetermined height. Accordingly, an upper end of the protruding rib 425 may have a predetermined gap G2 and may be disposed to be lower than an upper end of the inner cap 420. The gap G2 may function as a passage for guiding the electrolyte overflowing from the first insertion path 421a to a second insertion path 421b.

In some implementations, the inner cap 420 may include a second insertion path 421b. The second insertion path 421b may be disposed on an outer circumference of the first insertion path 421a with the protruding rib 425 interposed therebetween. The second insertion path 421b may be coupled to the second insertion portion 414b. In an embodiment, the second insertion path 421b may have a circular ring shape in a plane corresponding to the second insertion portion 414b.

Additionally, the second insertion path 421b may have a third length L3 vertically. A vertical length of the second insertion path 421b may be defined as a length from an upper of the protruding rib 425 to a bottom surface of the second insertion path 421b. Here, the third length L3 may be formed to be greater than the second length L2 of the second insertion portion 414b by a predetermined length. That is, the second insertion path 421b may be formed to be deeper than a protruding length of the second insertion portion 414b by a predetermined amount. Accordingly, the second insertion portion 414b may be disposed to have a predetermined gap G3 in the second insertion path 421b.

In some implementations, the inner cap 420 may include a discharge hole 426. The discharge hole 426 may be penetrated and formed upwardly and downwardly on the bottom surface of the inner cap 420 so as to be connected to the second insertion path 421b. The discharge hole 426 may provide a passage for a movement of gas or the like between the second insertion path 421b and a lower side of the inner cap 420 (i.e., an internal space of the case 110). A plurality of discharge holes 426 may be provided as needed, and the plurality of discharge holes 426 may be spaced apart from each other by a predetermined interval along the second insertion path 421b.

In some implementations, the cap plate 130 may include an electrolyte injection port 430.

The electrolyte injection port 430 may be penetrated and formed in the cap plate 130 to provide a passage for injecting the electrolyte into the internal space of the case 110.

In an embodiment, the electrolyte injection port 430 may have a size and a shape generally corresponding to the outer circumference of the inner cap 420. Additionally, a settling groove 435 may be provided on an outer circumference of the electrolyte injection port 430. A flange 424 of the inner cap 420 may be settled and supported in the settling groove 435. A second chamfer 433 may be formed in an upper side of the settling groove 435. The second chamfer 433 may be disposed to correspond to the first chamfer 413 of the outer cap 410 and may be used for welding bonding.

When looking into an operation of the sealing member 400 as described above, first, as illustrated in (a) of FIG. 4B, the inner cap 420 may be fastened to the electrolyte injection port 430. The inner cap 420 may be supported by the electrolyte injection port 430 as the flange 324 is settled and disposed in the settling groove 435. In some cases, the inner cap 420 may be fixed to the electrolyte injection port 430 through a tack welding or the like.

In the above-described state, the electrolyte may be injected into the case 110 through the first insertion path 421a. According to the electrolyte injection, the gas in the case 110 may be discharged to the outside through the discharge hole 426. In an embodiment, an electrolyte injection path and an internal gas discharge path may be separated, thereby inducing smooth injection of the electrolyte and smooth discharge of the internal gas together. Additionally, the electrolyte excessively injected through the first insertion path 421a may overflow the protruding rib 425 and may flow into the second insertion path 421b, and the injected electrolyte may be recovered back into the case 110 through the discharge hole 426.

Referring to (b) of FIG. 4B, thereafter, the inner cap 420 may be sealed by the outer cap 410. The outer cap 410 may be fastened to an upper portion of the inner cap 420 while the first insertion portion 414a is inserted into the first insertion path 421a of the inner cap 420 and the second insertion portion 414b is inserted into the second insertion path 421b of the inner cap 420. When the outer cap 410 is completely inserted thereinto, the outer cap 410 may be welded to the cap plate 130 at the first and second chamfers 413 and 433 and may be firmly fixed to the cap plate 130.

In some implementations, in a state in a state in which the outer cap 410 is fastened as described above, the second insertion portion 414b of the outer cap 410 may be spaced apart from the inner cap 420 by a predetermined gap G3. The gap G3 may be formed by a difference in length between the second insertion path 421b and the second insertion portion 414b. Additionally, the gap G3 may be connected to the discharge hole 426 of the inner cap 420. The above gap G1 can function as a means for buffering the internal pressure transmitted to the outer cap 410 after the outer cap 410 is fastened. Accordingly, external force transmitted to a welding portion of the outer cap 410 may be alleviated, and fatigue failure of the sealing member 400 due to repeated stress may be prevented.

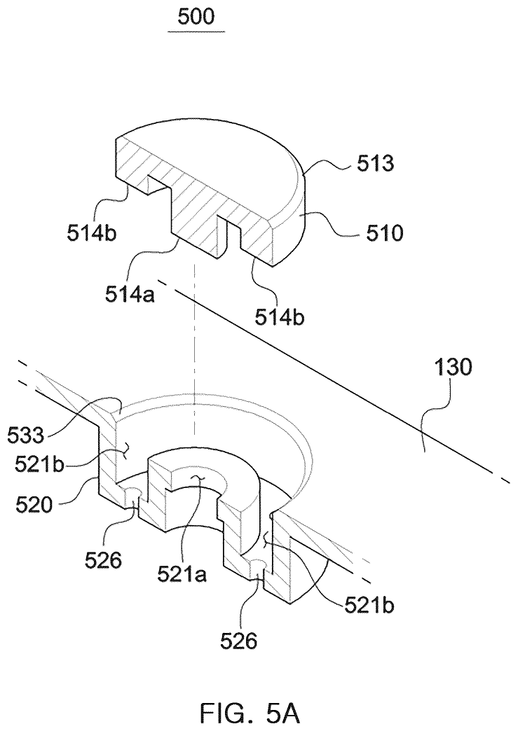

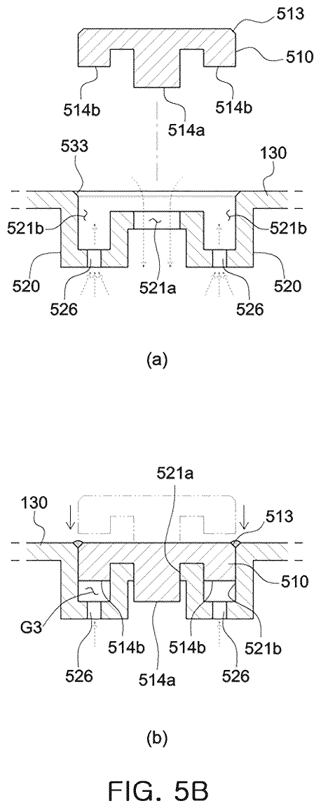

FIG. 5A is a schematic cross-sectional view of a sealing member based on another embodiment. FIGS. 5B(a) and 5B(b) are schematic assembly flow diagrams of the sealing member illustrated in FIG. 5A.

Referring to FIGS. 5A and 5B, a sealing member 500 based on an embodiment may include an outer cap 510 and an inner cap 520.

The outer cap 510 may be formed in a manner similar to the outer caps 210, 310 and 410 of the above-described embodiment. A first insertion portion 514a may be provided on a lower surface of the outer cap 510, and a second insertion portion 514b may be provided on an outer side centered on the first insertion portion 514a. The second insertion portion 514b may have a length shorter than a length of the first insertion portion 514a by a predetermined amount, and may be formed to extend in a circular ring shape on a plane centered on the first insertion portion 514a. Additionally, a first chamfer 513 may be formed on a circumference of an upper end of the outer cap 510.

In an embodiment, the inner cap 520 may be integrated with the cap plate 130. That is, the inner cap 520 may be formed as a portion of the cap plate 130.

The inner cap 520 may be formed generally similarly to the inner caps 220, 320 and 420 of the above-described embodiment except that inner cap 520 is integrated with the cap plate 130.

The inner cap 520 may have a protruding rib 525 protruding from a bottom surface by a predetermined height, and the protruding rib 525 may include a first insertion path 521a into which the first insertion portion 514a is inserted into and fastened. In contrast to the first insertion path 421a of the above-described embodiment, the first insertion path 521a of this embodiment has a shape similar to a hole. In an embodiment, the first insertion path 521a may be used as an electrolyte injection port for injecting the electrolyte into the case 110.

Additionally, the inner cap 520 may include a second insertion path 521b formed on an outer circumference of the protruding rib 525. The second insertion path 521b may be formed to be deeper than a protruding length of the corresponding second insertion portion 514b by a predetermined depth, thus forming a gap G3 from the second insertion portion 514b. Additionally, a discharge hole 526 providing a passage for gas, and the like, may be formed in a lower end of the second insertion path 521b. Additionally, a second chamfer 533 may be formed in a connection portion between the inner cap 520 and the cap plate 130.

Referring to (a) of FIG. 5B, the sealing member 500 as described above may be used to inject electrolyte or discharge gas through the inner cap 520 integrated with the cap plate 130.

Referring to (b) of FIG. 5B, the inner cap 520 may then be sealed by the outer cap 510. Similarly to the above-described embodiment, the outer cap 510 may be fastened to an upper portion of the inner cap 520 or the cap plate 130 as the first insertion portion 514a is inserted into the first insertion path 521a and the second insertion portion 514b is inserted into the second insertion path 521b. Additionally, the outer cap 510 may be welded to the cap plate 130 at the first and second chamfers 513 and 533 and may be firmly fixed to the cap plate 130.

In some implementations, in some other embodiments, the electrolyte injection port and the sealing members 200 to 500 as described above may be disposed in other components of the secondary battery 100 other than the cap plate 130. Alternatively, a portion or all of the cap plate 130 may be integrated with other components of the secondary battery 100, and the electrolyte injection port, and the like, may be disposed in other integrated components. For example, the electrolyte injection port may be disposed in a predetermined position of the case 110, and the sealing members 200 to 500 of the above-described embodiments may be used to seal the electrolyte injection port disposed in the case 110 in this manner.

As described above, the secondary battery according to embodiments of the disclosed technology may provide a sealing member for sealing the electrolyte injection port. The sealing member according to some embodiments of the disclosed technology may include an outer cap and an inner cap, and the inner cap may be formed to be elastically compressed by the outer cap. Accordingly, the sealing member may implement a more appropriate sealing structure in the case. Additionally, the sealing member may also enhance the safety of the secondary battery by responding to changes in the internal pressure of the case.

The sealing member based on some embodiments of the disclosed technology may include an outer cap and an inner cap, and a first insertion path and a second insertion path may be formed in the inner cap. The first insertion path may function as a passage for injecting the electrolyte, and the second insertion path may function as a passage for discharging gas inside the case. Accordingly, the first and second insertion paths may implement smoother injection of the electrolyte.

The disclosed technology can be implemented in the field of secondary batteries or rechargeable batteries that widely used in electric vehicles, uninterruptible power supplies, battery storage power stations, and others including battery power storage for solar panels, wind power generators and other green tech power generators. Specifically, the disclosed technology can be implemented in some applications to provide secondary batteries that can improve the battery reliability and performance and, accordingly, to mitigate climate change. Secondary batteries based on the disclosed technology can be used to address various adverse effects such as air pollution and greenhouse emissions by powering electric vehicles (EVs) as alternatives to vehicles using fossil fuel based engines and by providing battery based energy storage systems (ESS) to store renewable energy such as solar power and wind power.

Only specific examples of implementations of certain embodiments are described. Variations, improvements and enhancements of the disclosed embodiments and other embodiments may be made based on the disclosure of this patent document.

What is claimed is:

1. A secondary battery, comprising:
a case structured to accommodate an electrode assembly;
a cap plate disposed on the case to seal an opening of the case;
an electrolyte injection port disposed in the cap plate to inject an electrolyte into an internal space of the case;
a sealing member configured to seal the electrolyte injection port,
wherein the sealing member includes:
an inner cap fastened to an inner surface of the electrolyte injection port; and
an outer cap inserted into and fastened to the inner cap and configured to elastically compress the inner cap toward the inner surface.

2. The secondary battery of claim 1,
wherein the outer cap is screw-coupled to the inner cap and configured to gradually elastically compress the inner cap toward the inner surface of the electrolyte injection port as the outer cap moves inwardly by the screw-coupling.

3. The secondary battery of claim 1,
wherein the inner cap includes an insertion path configured to receive the outer cap,
wherein a diameter of the insertion path gradually decreases in an insertion direction of the outer cap.

4. The secondary battery of claim 1,
wherein the inner cap includes an outer surface of the electrolyte injection port fastened to the inner surface of the electrolyte injection port,
wherein a diameter of the outer surface gradually decreases in an insertion direction of the outer cap.

5. The secondary battery of claim 4,
wherein a diameter of the inner surface of the electrolyte injection port gradually decreases in the insertion direction of the outer cap to correspond to the outer surface of the electrolyte injection port, and
the inner cap is supported in the electrolyte injection port by aligning the outer surface of the electrolyte injection port with the inner surface of the electrolyte injection port.

6. The secondary battery of claim 1,
wherein the outer cap includes an insertion portion inserted into the inner cap,
wherein a diameter of the insertion portion gradually decreases in an insertion direction of the outer cap.

7. The secondary battery of claim 1,
wherein the inner cap is formed such that an outer surface of the electrolyte injection port has a predetermined diameter extending both upwardly and downwardly,
wherein a flange supported by a step surface formed in the electrolyte injection port is disposed at an upper end of the outer surface of the electrolyte injection port.

8. The secondary battery of claim 1,
wherein the inner cap is structured such that a degree of elastic compression in a transverse direction varies between an upper region and a lower region depending on an insertion direction of the outer cap.

9. The secondary battery of claim 1,
wherein at least a portion of the inner cap includes an elastic material, and
the outer cap includes a hard material compared to the inner cap, and is welded and fixed to the cap plate.

10. The secondary battery of claim 1,
wherein the cap plate includes a first cap plate disposed on a first side of the case and a second cap plate disposed on a second side of the case opposite to the first side, and
the electrolyte injection port includes at least one of: a first electrolyte injection port included in the first cap plate; or a second electrolyte injection port included in the second cap plate.

11. A secondary battery, comprising:
a case structured to accommodate an electrode assembly;
a cap plate disposed on the case to seal an opening of the case;
an electrolyte injection port included in the cap plate to inject an electrolyte into an internal space of the case; and
a sealing member configured to seal the electrolyte injection port,
wherein the sealing member includes:
an inner cap including: a first insertion path to provide an injection path for an electrolyte; and a second insertion path to provide an exhaust path for internal gas during an electrolyte injection, and
an outer cap including: a first insertion portion inserted into and fastened to the first insertion path to seal the first insertion path; and a second insertion portion inserted into and fastened to the second insertion path.

12. The secondary battery of claim 11,
wherein the inner cap includes a protruding rib extending upward from a bottom surface of the inner cap by a predetermined height to form the first insertion path,
wherein the protruding rib is formed such that an upper end of the protruding rib includes a predetermined gap and is disposed to be lower than an upper end of the inner cap, wherein the protruding rib is configured to guide the electrolyte overflowing from the first insertion path through the gap to the second insertion path.

13. The secondary battery of claim 11,
wherein the inner cap includes a discharge hole that communicates with the second insertion path, and
the second insertion portion is spaced apart from the discharge hole by a predetermined gap, wherein the gap is formed to buffer internal pressure transmitted to the outer cap.

14. The secondary battery of claim 11,
wherein the inner cap include a flange placed and supported within a settling groove provided in the cap plate.

15. The secondary battery of claim 11,
wherein the outer cap includes a first chamfer aligned with a second chamfer disposed on the cap plate, and is welded and bonded to the cap plate.

16. The secondary battery of claim 11,
wherein at least a portion of the inner cap is integrated with the cap plate.
